(19) United States
(12) Patent Application Publication
(10) Pub. No.: US 2013/0236104 A1
(43) Pub. Date: Sep. 12, 2013

(54) Apparatus and Method of Processing an Image

(71) Applicant: SAMSUNG ELECTRONICS CO., LTD., Suwon-si (KR)

(72) Inventors: Dong-jae Lee, Osan-si (KR); Young-sung CHO, Anyang-si (KR); Tae-chan KIM, Yongin-si (KR)

(73) Assignee: Samsung Electronics Co., Ltd., Suwon-si (KR)

(21) Appl. No.: 13/788,910

(22) Filed: Mar. 7, 2013

(30) Foreign Application Priority Data
Mar. 7, 2012 (KR) 10-2012-0023602

(51) Int. Cl. G06T 7/00

(52) U.S. Cl. CPC G06T 7/0042
USPC 382/195

(57) ABSTRACT

An image processing apparatus processes a center pixel by using a plurality of adjacent pixels included in an M×N region. The image processing apparatus includes a pixel value storage unit for storing first pixel values that correspond to first pixels included in one or more rows including a center row in which the center pixel is disposed, and second pixel values that correspond to second pixels disposed above the first pixels from among the plurality of adjacent pixels; and a pixel processing unit for processing the center pixel, based on the first and second pixel values, wherein the M and N are natural numbers that are equal to or greater than two.

### CROSS-REFERENCE TO RELATED APPLICATIONS

This application claims the benefit of Korean Patent Application No. 10-2012-0023602, filed on Mar. 7, 2012, in the Korean Intellectual Property Office, the disclosure of which is incorporated herein in its entirety by reference.

### BACKGROUND

The inventive concept relates to image processing, and, more particularly, to an image processing apparatus and a method thereof.

Image processing may be divided into point processing, region processing, geometric processing, or frame processing. The point processing involves converting and processing an image according to a pixel value or a pixel position, and the region processing involves converting and processing an image by using a neighboring pixel value. The geometric processing involves converting and processing a pixel position or a pixel array, and the frame processing involves generating a pixel value by processing two or more images.

### SUMMARY

According to an aspect of the inventive concept, there is provided an image processing apparatus for processing a center pixel by using a plurality of adjacent pixels comprised in an M×N region, the image processing apparatus including a pixel value storage unit for storing first pixel values that correspond to first pixels comprised in one or more rows comprising a center row in which the center pixel is disposed, and second pixel values that correspond to second pixels disposed above the first pixels from among the plurality of adjacent pixels; and a pixel processing unit for processing the center pixel, based on the first and second pixel values, wherein the M and N are natural numbers that are equal to or greater than two.

The number of the first and second pixel values stored in the pixel value storage unit may be less than the number of pixel values that correspond to pixels included in (M−1) rows.

The pixel value storage unit may include a line memory for storing the first pixel values; and a memory for storing the second pixel values. The number of the first pixel values stored in the line memory may be less than the number of pixel values that correspond to pixels comprised in (M−1) rows.

The pixel value storage unit may include a line memory for storing the first and second pixel values.

The image processing apparatus may further include an identification (ID) information storage unit for storing ID information that is used to identify a center pixel value corresponding to the center pixel from among a plurality of pixel values that are sequentially input. The ID information may include coordinate information regarding the center pixel and/or input order information regarding the center pixel.

The image processing apparatus may further include an input buffer for storing a plurality of pixel values that are sequentially input. The input buffer may store third pixel values corresponding to third pixels that are comprised in an Mₜₕ row and that are from among the plurality of adjacent pixels.

The image processing apparatus may further include an adjacent region generating unit for generating an adjacent region comprising the plurality of adjacent pixels, based on the first, second, and third pixel values. The pixel processing unit may change or maintain a center pixel value of the center pixel by using the generated adjacent region.

The image processing apparatus may further include a kernel size determining unit for selectively determining values of the M and N numbers and then determining a size of a kernel that is the M×N region.

The center pixel may be a defective pixel, and the pixel processing unit may correct a value of the defective pixel, based on the first and second pixel values.

According to another aspect of the inventive concept, there is provided a method of processing an image by processing a center pixel by using a plurality of adjacent pixels included in an M×N region, the method including operations of storing first pixel values that correspond to first pixels comprised in one or more rows including a center row in which the center pixel is disposed, and second pixel values that correspond to second pixels disposed above the first pixels from among the plurality of adjacent pixels; and processing the center pixel, based on the first and second pixel values, wherein the M and N are natural numbers that are equal to or greater than two.

The method may further include operations of storing third pixel values corresponding to third pixels that are comprised in an Mₜₕ row and that are from among the plurality of adjacent pixels; and generating an adjacent region comprising the plurality of adjacent pixels, based on the first, second, and third pixel values.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram of an image processing apparatus according to an embodiment of the inventive concept;

FIG. 2 illustrates an example of an M×N region used in the image processing apparatus of FIG. 1;

FIG. 3 illustrates an example of identification (ID) information stored in an ID information storage unit of FIG. 1;

FIG. 4 illustrates another example of ID information stored in the ID information storage unit of FIG. 1;

FIG. 5 illustrates pixel values stored in an image processing apparatus according to a comparative example;

FIG. 6 illustrates an example of first, second, and third pixel values that are provided by a pixel value storage unit and an input buffer, according to an embodiment of the present invention;

FIG. 7 illustrates an example of first, second, and third pixel values that are provided by the pixel value storage unit and the input buffer, according to another embodiment of the present invention;

FIG. 8 illustrates an example of the M×N region used in the image processing apparatus of FIG. 1, according to an embodiment of the present invention;

FIG. 9 illustrates an example of first, second, and third pixel values that are stored in the pixel value storage unit and the input buffer of FIG. 1 when the M×N region of FIG. 8 is used, according to an embodiment of the present invention;

FIG. 10 illustrates an example of first, second, and third pixel values that are stored in the pixel value storage unit and the input buffer of FIG. 1 when the M×N region of FIG. 8 is used, according to another embodiment of the present invention;

FIG. 11 illustrates an example of the M×N region used in the image processing apparatus of FIG. 1, according to another embodiment of the present invention;

FIG. 12 illustrates an example of first, second, and third pixel values that are stored in the pixel value storage unit and the input buffer of FIG. 1 when the M×N region of FIG. 11 is used, according to an embodiment of the present invention;

FIG. 13 illustrates an example of first, second, and third pixel values that are stored in the pixel value storage unit and the input buffer of FIG. 1 when the M×N region of FIG. 11 is used, according to another embodiment of the present invention;

FIG. 14 illustrates an example of the M×N region used in the image processing apparatus of FIG. 1, according to another embodiment of the present invention;

FIG. 15 illustrates an example of first, second, and third pixel values that are stored in the pixel value storage unit and the input buffer of FIG. 1 when the M×N region of FIG. 14 is used, according to an embodiment of the present invention;

FIG. 16 illustrates an example of first, second, and third pixel values that are stored in the pixel value storage unit and the input buffer of FIG. 1 when the M×N region of FIG. 14 is used, according to another embodiment of the present invention;

FIG. 17 is a block diagram of an image processing apparatus according to another embodiment of the inventive concept;

FIG. 18 is a block diagram of an image processing apparatus according to another embodiment of the inventive concept;

FIGS. 19A through 19C illustrate examples of kernels that have sizes determined by a kernel size determining unit of FIG. 18;

FIG. 20 is a block diagram of an image processing apparatus according to another embodiment of the inventive concept;

FIG. 21 is a flowchart illustrating a method of processing an image, according to an embodiment of the present invention;

FIG. 22 is a block diagram of a photographing device including one of the image processing apparatuses, according to an embodiment of the present invention;

FIG. 23 is a detailed block diagram of an image sensor of FIG. 22;

FIG. 24 is a block diagram of a computing system that includes a photographing device of FIG. 22, according to an embodiment of the inventive concept; and

FIG. 25 is a block diagram illustrating an interface used in the computing system of FIG. 24.

### DETAILED DESCRIPTION OF THE EMBODIMENTS

The inventive concept will now be described more fully with reference to the accompanying drawings, in which exemplary embodiments of the inventive concept are shown. The inventive concept may, however, be embodied in many different forms and should not be construed as being limited to the embodiments set forth herein; rather, these embodiments are provided so that this disclosure will be thorough and complete, and will fully convey the inventive concept to those of ordinary skill in the art. Thus, the inventive concept may include all revisions, equivalents, or substitutions which are included in the concept and the technical scope related to the inventive concept. Like reference numerals in the drawings denote like elements. In the drawings, the thicknesses of layers and regions are exaggerated for clarity.

Furthermore, all examples and conditional language recited herein are to be construed as being without limitation to such specifically recited examples and conditions. Throughout the specification, a singular form may include a plural form, unless there is a particular description contrary thereto. Also, terms such as “comprise” or “comprising” are used to specify existence of a recited form, a number, a process, an operation, a component, and/or groups thereof, not excluding the existence of one or more other recited forms, one or more other numbers, one or more other processes, one or more other operations, one or more other components and/or groups thereof.

While terms “first” and “second” are used to describe various components, it is obvious that the components are not limited to the terms “first” and “second”. The terms “first” and “second” are used only to distinguish between each component. For example, a first component may indicate a second component or a second component may indicate a first component without conflicting with the inventive concept.

Unless expressly described otherwise, all terms including descriptive or technical terms which are used herein should be construed as having meanings that are obvious to one of ordinary skill in the art. Also, terms that are defined in a general dictionary and that are used in the following description should be construed as having meanings that are equivalent to meanings used in the related description, and unless expressly described otherwise herein, the terms should not be construed as being ideal or excessively formal.

As used herein, the term “and/or” includes any and all combinations of one or more of the associated listed items.

FIG. 1 is a block diagram of an image processing apparatus 1A according to an embodiment of the inventive concept.

Referring to FIG. 1, the image processing apparatus 1A may include an identification (ID) information storage unit 10, a pixel value storage unit 20a, an input buffer 30, an adjacent region generating unit 40, and a pixel processing unit 50. The pixel value storage unit 20a may include a first pixel value storage unit 21 and a second pixel value storage unit 22.

In the present embodiment, the image processing apparatus 1A may be a center pixel processing apparatus or a defective pixel processing apparatus, which processes a center pixel or a defective pixel by using adjacent pixels. The defective pixel or an error pixel indicates a signal that generates a very large or small signal in a certain environment, compared to the adjacent pixels. The defective pixel includes a hot pixel that is always turned on, a dead pixel that is always turned off, and a stuck pixel that indicates one or more sub-pixels that are always turned on or off.

An image sensor (not shown) converts an optical signal received via a lens into an electrical signal. Representative applications of the image sensor include a mobile phone camera and a digital camera, and because these products have become small, a size of the image sensor is limited. Also, the image sensor includes a plurality of devices, and thus, there is a possibility that an error occurs in a manufacturing process of the image sensor. Furthermore, because the number of pixels included in the image sensor is increased, the number of defective pixels that are incurred by the error of the manufacturing process also increases. In this regard, the increase in defective pixels deteriorates a performance of the image sensor, so that it is required to detect and correct the defective pixels so as to reduce or prevent the deterioration.

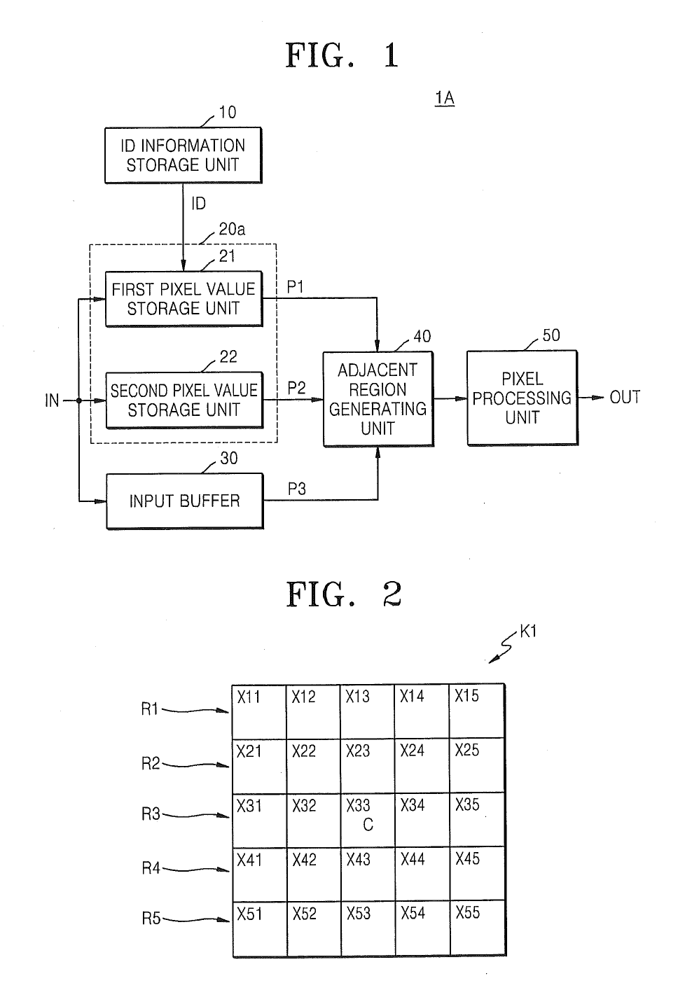

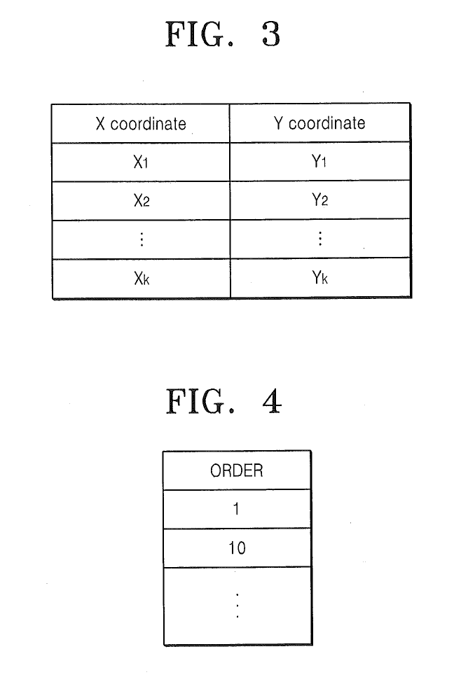

FIG. 2 illustrates an example of an M×N region used in the image processing apparatus 1A of FIG. 1.

Referring to FIG. 2, the M×N region includes M rows and N columns, where each of M and N is a natural number that is equal to or greater than 2. In the present embodiment, each of M and N may be 5, and a 5×5 region may include first through fifth rows R1 through R5. A center pixel C to be processed is disposed in the third row R3, which is a center row. In the M×N region, a center row may be a (M+1)/2ₜₕ row. The first and second rows R1 and R2 are disposed above the third row R3, i.e., the center row, and the fourth and fifth rows R4 and R5 are disposed below the third row R3, i.e., the center row.

The M×N region may be a kernel that is generated by grouping a plurality of pixel values IN by M×N, wherein the pixel values IN are sequentially input. In the present embodiment, a kernel K1 includes a center pixel value X33 that corresponds to the center pixel C to be processed, and adjacent pixel values X11 through X15, X21 through X25, X31, X32, X34, X35, X41 through X45, and X51 through X55 that correspond to a plurality of adjacent pixels to the center pixel C.

When the center pixel C is a defective pixel, and the plurality of adjacent pixels are normal pixels, the center pixel value X33 may be corrected by using an average of the adjacent pixel values X11 through X15, X21 through X25, X31, X32, X34, X35, X41 through X45, and X51 through X55. Alternatively, the center pixel value X33 may be corrected by applying a weight to some of the adjacent pixel values from among the adjacent pixel values X11 through X15, X21 through X25, X31, X32, X34, X35, X41 through X45, and X51 through X55 and then by using a weighted average of the adjacent pixel values to which the weight is applied, and the rest of the adjacent pixel values. Alternatively, the center pixel value X33 may be corrected by using a value of a nearest adjacent pixel from among the adjacent pixel values X11 through X15, X21 through X25, X31, X32, X34, X35, X41 through X45, and X51 through X55.

Referring to FIGS. 1 and 2, the ID information storage unit 10 may store ID information that is used to identify the center pixel value X33 corresponding to the center pixel C from among the plurality of pixel values IN that are sequentially input. Also, the ID information storage unit 10 may provide the stored ID information to the pixel value storage unit 20a. For example, the ID information storage unit 10 may be embodied as a non-volatile memory device, a one time programmable erasable programmable read-only memory (OTP EPROM), an e-fuse, and the like.

Here, the ID information may include coordinate information regarding the center pixel C, input order information regarding the center pixel C, or the like. In other words, to identify the center pixel value X33 corresponding to the center pixel C from among the plurality of pixel values IN that are sequentially input, the ID information may index the center pixel value X33. Hereinafter, examples of the ID information will be described with reference to FIGS. 3 and 4.

FIG. 3 illustrates an example of ID information stored in the ID information storage unit 10 of FIG. 1.

Referring to FIG. 3, the ID information storage unit 10 may store coordinate information regarding the center pixel C, i.e., the ID information storage unit 10 may store coordinate values of the center pixel C as the ID information. Here, the ID information storage unit 10 may store the coordinate values of the center pixel C as a horizontal axis coordinate value (i.e., an X coordinate) and a vertical axis coordinate value (i.e., a Y coordinate). Because a plurality of pixels are included in the form of a pixel array in an image sensor (not shown), if the coordinate values of the center pixel C to be processed are known, it is possible to identify the center pixel value X33 corresponding to the center pixel C from among the plurality of pixel values IN. For example, the ID information storage unit 10 stores coordinate values of k center pixels, e.g., (X₁, Y₁), (X₂, Y₂), . . . , (Xₖ, Yₖ).

FIG. 4 illustrates another example of ID information stored in the ID information storage unit 10 of FIG. 1.

Referring to FIG. 4, the ID information storage unit 10 may store input order information as the ID information, wherein the input order information is related to an input order of a pixel value X33 that corresponds to the center pixel C. Because the plurality of pixel values IN are sequentially input to the image processing apparatus 1A, if an input order of the center pixel value X33 that corresponds to the center pixel C to be processed is known, it is possible to identify the center pixel value X33 corresponding to the center pixel C from among the plurality of pixel values IN. For example, the ID information storage unit 10 may store 1, 10, or the like as the input order of the center pixel C, and then a value of a pixel that is first input and a value of a pixel that is input 10^{th} from among the plurality of pixel values IN that are sequentially input may be center pixel values.

Referring back to FIGS. 1 and 2, the pixel value storage unit 20a may store a few pixel values from among the plurality of pixel values IN that are sequentially input, based on the ID information. In the present embodiment, the number of pixel values stored in the pixel value storage unit 20a may be less than the number of pixel values that correspond to pixels included in (M−1) rows. In more detail, the pixel value storage unit 20a may include the first pixel value storage unit 21 and the second pixel value storage unit 22.

Based on the ID information, the first pixel value storage unit 21 may store first pixel values P1 that correspond to first pixels included in one or more rows including a center row (i.e., a (M+1)/2ₜₕ row) in which the center pixel Cfrom among the plurality of pixel values IN that are sequentially input is disposed. In the present embodiment, the first pixel value storage unit 21 may store first pixel values P1 that correspond to first pixels included in one or more rows including the third row R3 in which the center pixel Cis disposed. In the present embodiment, the first pixel value storage unit 21 may be embodied as a line memory.

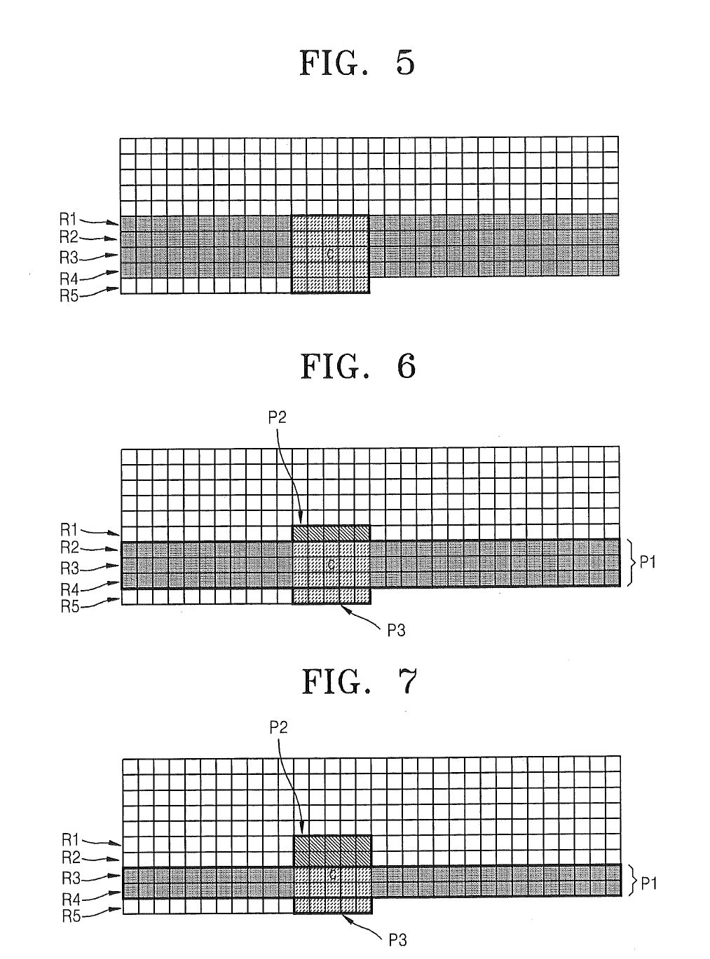

In an embodiment, the first pixel value storage unit 21 may store first pixel values P1 that correspond to first pixels included in a center row through a (M−1)ₜₕ row. In another embodiment, the first pixel value storage unit 21 may store first pixel values P1 that correspond to first pixels included in the second row R2 through the (M−1)ₜₕ row. This will be described in detail with reference to FIGS. 5 through 7.

The second pixel value storage unit 22 may store second pixel values P2 that correspond to second pixels disposed above the first pixels from among the plurality of adjacent pixels included in the M×N region. In more detail, the second pixel value storage unit 22 may store the second pixel values P2, i.e., residual pixel values of the plurality of adjacent pixels included in the M×N region, except for the first pixel values P1 that are stored in the first pixel value storage unit 21 and third pixel values P3 that are included in an Mₜₕ row. In the present embodiment, the second pixel value storage unit 22 may be embodied as one memory.

The input buffer 30 may store the plurality of pixel values IN that are sequentially input, and a size of the input buffer 30 may vary according to a value of N. In more detail, the input buffer 30 may store the third pixel values P3 corresponding to N third pixels that are included in the Mₜₕ row and that are from among the plurality of adjacent pixels included in the M×N region. In the present embodiment, the input buffer 30 may be embodied as a flip-flop.

The adjacent region generating unit 40 may generate an adjacent region including a plurality of adjacent pixels used to process the center pixel C, based on the first, second, and third pixel values P1, P2, and P3 that are provided by the pixel value storage unit 20a and the input buffer 30. In the present embodiment, the adjacent region generating unit 40 may generate an adjacent region including a plurality of adjacent pixels included in a 5×5 region, based on the first, second, and third pixel values P1, P2, and P3.

The pixel processing unit 50 may output a center pixel value OUT that is corrected by processing the center pixel C by using the adjacent region that is generated by the adjacent region generating unit 40. In more detail, the pixel processing unit 50 may output the center pixel value OUT that is corrected by changing or maintaining the center pixel value X33 of the center pixel C by using the generated adjacent region. When the center pixel C is a defective pixel, the pixel processing unit 50 may correct a pixel value of the defective pixel by using the generated adjacent region.

FIG. 5 illustrates pixel values stored in an image processing apparatus according to a comparative example.

Referring to FIG. 5, when a plurality of adjacent pixels included in a 5×5 region are required to process a center pixel C, a memory included in the image processing apparatus according to the related art stores pixel values that correspond to pixels included in first through fourth rows R1 through R4. Thus, four line memories are used to store the pixel values that correspond to the pixels included in the first through fourth rows R1 through R4.

Here, because the four line memories also store pixel values that correspond to pixels other than the plurality of adjacent pixels used to process the center pixel C, a large capacity of a hardware size may be used. For example, 32 pixel values may be stored in one line memory, and thus 128 (=32×4) pixel values may be stored in the four line memories.

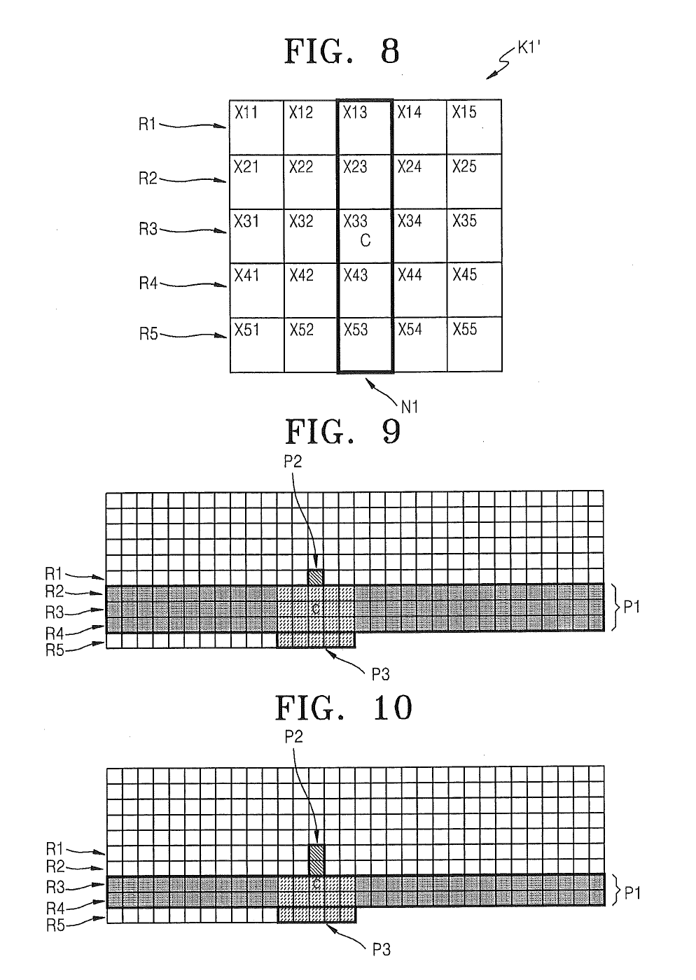

FIG. 6 illustrates an example of first, second, and third pixel values P1, P2, and P3 that are provided by the pixel value storage unit 20a and the input buffer 30, according to an embodiment of the present invention.

Referring to FIG. 6, the first pixel value storage unit 21 may store the first pixel values P1 that correspond to first pixels included in three rows, including a center row in which a center pixel C is disposed. In more detail, the first pixel value storage unit 21 may store the first pixel values P1 that correspond to first pixels included in a third row R3 in which the center pixel C is disposed, a second row R2 above the third row R3, and a fourth row R4 below the third row R3. In this case, the first pixel value storage unit 21 may be embodied as three line memories.

The second pixel value storage unit 22 may store the second pixel values P2 that correspond to second pixels that are included in a first row R1 and that are from among the plurality of adjacent pixels included in the 5×5 region. In the present embodiment, the second pixel value storage unit 22 may store five second pixel values P2.

The input buffer 30 may store the third pixel values P3 corresponding to third pixels that are included in a fifth row R5 and that are from among the plurality of adjacent pixels included in the 5×5 region. Here, the input buffer 30 may store five third pixel values P3.

According to the present embodiment, the first pixel value storage unit 21 may store 96(=32×3) pixel values, and the second pixel value storage unit 22 may store the five second pixel values P2. Thus, the pixel value storage unit 20a may store 101(=96+5) pixel values, and compared to the comparative example of FIG. 5, the pixel value storage unit 20a stores 27 less pixel values. Thus, according to the present embodiment, a memory capacity required to store the first and second pixel values P1 and P2 is decreased.

FIG. 7 illustrates another example of first, second, and third pixel values P1, P2, and P3 that are provided by the pixel value storage unit 20a and the input buffer 30, according to another embodiment of the present invention.

Referring to FIG. 7, the first pixel value storage unit 21 may store the first pixel values P1 that correspond to first pixels included in two rows, including a center row in which a center pixel C is disposed. In more detail, the first pixel value storage unit 21 may store the first pixel values P1 that correspond to first pixels included in a third row R3 in which the center pixel C is disposed, and a fourth row R4 below the third row R3. In this case, the first pixel value storage unit 21 may be embodied as two line memories.

The second pixel value storage unit 22 may store the second pixel values P2 that correspond to second pixels that are included in first and second rows R1 and R2 and that are from among the plurality of adjacent pixels included in the 5×5 region. In the present embodiment, the second pixel value storage unit 22 may store 10(˜5×2) second pixel values P2.

The input buffer 30 may store the third pixel values P3 corresponding to third pixels that are included in a fifth row R5 and that are from among the plurality of adjacent pixels included in the 5×5 region. Here, the input buffer 30 may store five third pixel values P3.

According to the present embodiment, the first pixel value storage unit 21 may store 64(˜32×2) pixel values, and the second pixel value storage unit 22 may store the 10(=5×2) second pixel values P2. Thus, the pixel value storage unit 20a may store 74(=64+10) pixel values, and compared to the comparative example of FIG. 5, the pixel value storage unit 20a stores 54 less pixel values. Thus, according to the present embodiment, a memory capacity required to store the first and second pixel values P1 and P2 is decreased.

FIG. 8 illustrates an example of the M×N region used in the image processing apparatus 1A of FIG. 1, according to an embodiment of the present invention.

Referring to FIG. 8, each of M and N may be 5, and a 5×5 region may include first through fifth rows R1 through R5. Thus, a kernel K1′ includes a center pixel value X33 that corresponds to a center pixel C to be processed, and adjacent pixel values X11 through X15, X21 through X25, X31, X32, X34, X35, X41 through X45, and X51 through X55 that correspond to a plurality of adjacent pixels to the center pixel C.

In the present embodiment, the center pixel C may be processed by using adjacent pixel values N1, i.e., the adjacent pixel values X13, X23, X43, and X53 of the adjacent pixels from among the plurality of adjacent pixels, which are marked by a bold line. In this case, according to the related art, pixel values that correspond to pixels included in the first through fourth rows R1 through R4 are all stored.

FIG. 9 illustrates an example of first, second, and third pixel values P1, P2, and P3 that are stored in the pixel value storage unit 20a and the input buffer 30 of FIG. 1 when the M×N region of FIG. 8 is used, according to an embodiment of the present invention.

Referring to FIG. 9, the first pixel value storage unit 21 may store the first pixel values P1 that correspond to first pixels included in second through fourth rows R2 through R4. Also, the second pixel value storage unit 22 may store only a pixel value X13 that is included in a first row R1 and that is from among adjacent pixels included in a 5×5 region. Here, the pixel value X13 corresponds to a second pixel value P2. Also, the input buffer 30 may store third pixel values P3 corresponding to third pixels that are included in a fifth row R5 and that are from among the adjacent pixels included in the 5×5 region.

According to the present embodiment, the first pixel value storage unit 21 may store 96(=32×3) pixel values, and the second pixel value storage unit 22 may store one pixel value. Thus, the pixel value storage unit 20a may store 97(=96+1) pixel values, and compared to the comparative example of FIG. 5, the pixel value storage unit 20a stores 31 less pixel values. Thus, according to the present embodiment, a memory capacity required to store the first and second pixel values P1 and P2 is decreased.

FIG. 10 illustrates an example of first, second, and third pixel values P1, P2, and P3 that are stored in the pixel value storage unit 20a and the input buffer 30 of FIG. 1 when the M×N region of FIG. 8 is used, according to another embodiment of the present invention.

Referring to FIG. 10, the first pixel value storage unit 21 may store the first pixel values P1 that correspond to first pixels included in third and fourth rows R3 and R4. Also, the second pixel value storage unit 22 may store only pixel values X13 and X23 that are included in first and second rows R1 and R2 and that are from among adjacent pixels included in a 5×5 region. Here, the pixel values X13 and X23 correspond to second pixel values P2. Also, the input buffer 30 may store third pixel values P3 corresponding to third pixels that are included in a fifth row R5 and that are from among the adjacent pixels included in the 5×5 region.

According to the present embodiment, the first pixel value storage unit 21 may store 64(=32×2) pixel values, and the second pixel value storage unit 22 may store two pixel values. Thus, the pixel value storage unit 20a may store 66(=64+2) pixel values, and compared to the comparative example of FIG. 5, the pixel value storage unit 20a stores 62 less pixel values. Thus, according to the present embodiment, a memory capacity required to store the first and second pixel values P1 and P2 is decreased.

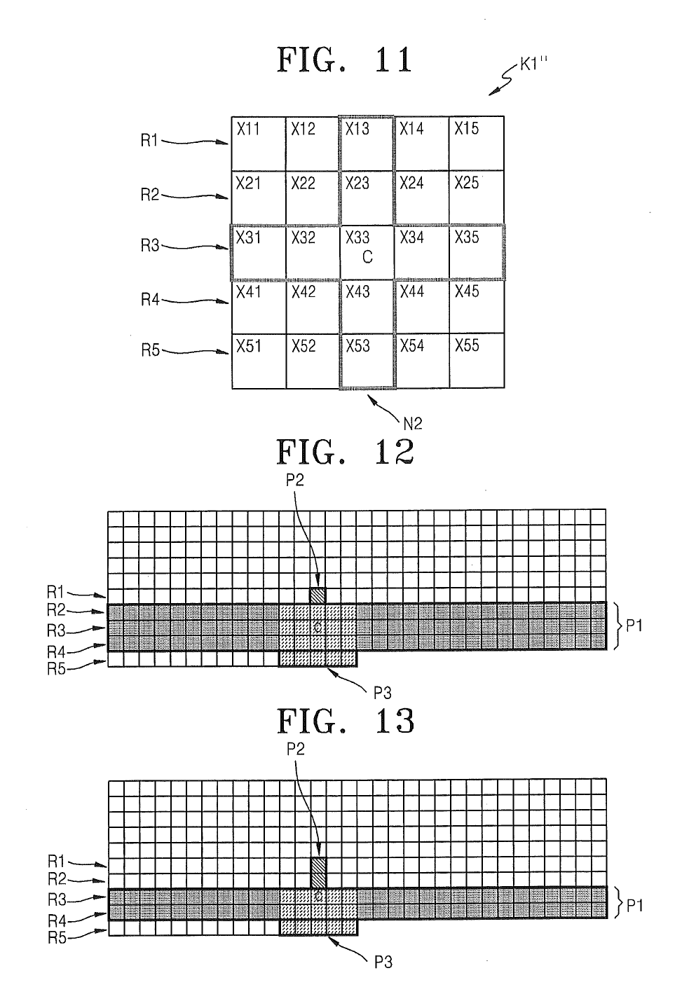

FIG. 11 illustrates an example of the M×N region used in the image processing apparatus 1A of FIG. 1, according to another embodiment of the present invention.

Referring to FIG. 11, each of M and N may be 5, and a 5×5 region may include first through fifth rows R1 through R5. Thus, a kernel K1″ includes a center pixel value X33 that corresponds to a center pixel C to be processed, and adjacent pixel values X11 through X15, X21 through X25, X31, X32, X34, X35, X41 through X45, and X51 through X55 that correspond to a plurality of adjacent pixels to the center pixel C.

In the present embodiment, the center pixel C may be processed by using adjacent pixel values N2, i.e., the adjacent pixel values X13, X23, X31, X32, X34, X35, X43, and X53 of the adjacent pixels from among the plurality of adjacent pixels, which are marked by a bold line. In this case, according to the related art, pixel values that correspond to pixels included in the first through fourth rows R1 through R4 are all stored.

FIG. 12 illustrates an example of first, second, and third pixel values P1, P2, and P3 that are stored in the pixel value storage unit 20a and the input buffer 30 of FIG. 1 when the M×N region of FIG. 11 is used, according to an embodiment of the present invention.

Referring to FIG. 12, the first pixel value storage unit 21 may store the first pixel values P1 that correspond to first pixels included in second through fourth rows R2 through R4. Also, the second pixel value storage unit 22 may store only a pixel value X13 that is included in a first row R1 and that is from among adjacent pixels included in a 5×5 region. Here, the pixel value X13 corresponds to a second pixel value P2. Also, the input buffer 30 may store third pixel values P3 corresponding to third pixels that are included in a fifth row R5 and that are from among the adjacent pixels included in the 5×5 region.

According to the present embodiment, the first pixel value storage unit 21 may store 96(=32×3) pixel values, and the second pixel value storage unit 22 may store one pixel value. Thus, the pixel value storage unit 20a may store 97(=96+1) pixel values, and compared to the comparative example of FIG. 5, the pixel value storage unit 20a stores 31 less pixel values. Thus, according to the present embodiment, a memory capacity required to store the first and second pixel values P1 and P2 is decreased.

FIG. 13 illustrates an example of first, second, and third pixel values P1, P2, and P3 that are stored in the pixel value storage unit 20a and the input buffer 30 of FIG. 1 when the M×N region of FIG. 11 is used, according to another embodiment of the present invention.

Referring to FIG. 13, the first pixel value storage unit 21 may store the first pixel values P1 that correspond to first pixels included in third and fourth rows R3 and R4. Also, the second pixel value storage unit 22 may store only pixel values X13 and X23 that are included in first and second rows R1 and R2 and that are from among adjacent pixels included in a 5×5 region. Here, the pixel values X13 and X23 correspond to second pixel values P2. Also, the input buffer 30 may store third pixel values P3 corresponding to third pixels that are included in a fifth row R5 and that are from among the adjacent pixels included in the 5×5 region.

According to the present embodiment, the first pixel value storage unit 21 may store 64(=32×2) pixel values, and the second pixel value storage unit 22 may store two pixel values. Thus, the pixel value storage unit 20a may store 66(=64+2) pixel values, and compared to the comparative example of FIG. 5, the pixel value storage unit 20a stores 62 less pixel values. Thus, according to the present embodiment, a memory capacity required to store the first and second pixel values P1 and P2 is decreased.

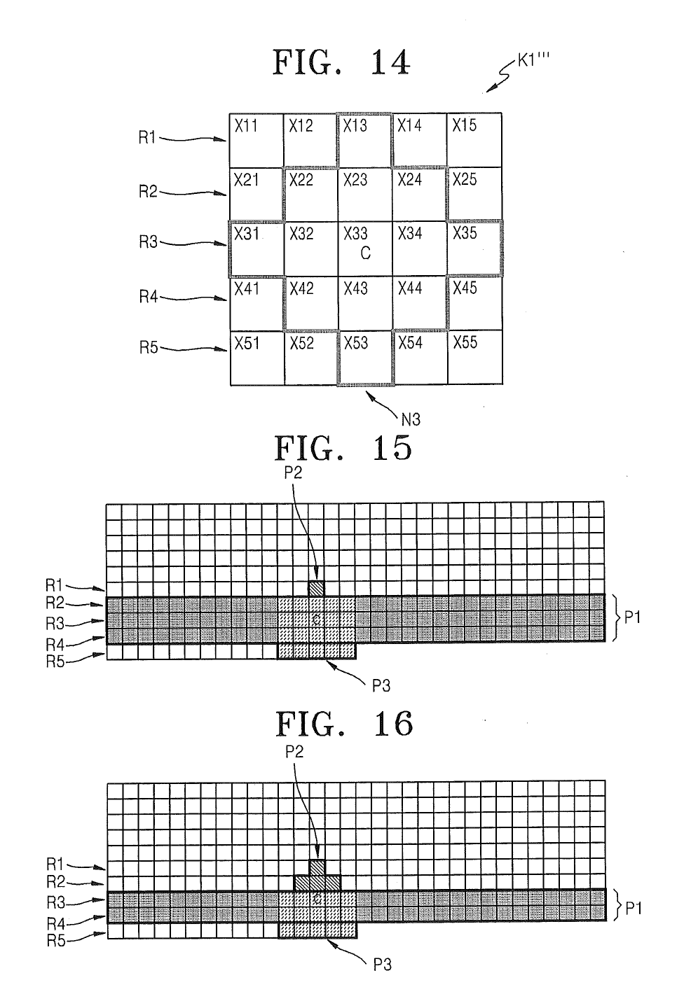

FIG. 14illustrates an example of the M×N region used in the image processing apparatus 1A of FIG. 1, according to another embodiment of the present invention.

Referring to FIG. 14, each of M and N may be 5, and a 5×5 region may include first through fifth rows R1 through R5. Thus, a kernel K1′″ includes a center pixel value X33 that corresponds to a center pixel C to be processed, and adjacent pixel values X11 through X15, X21 through X25, X31, X32, X34, X35, X41 through X45, and X51 through X55 that correspond to a plurality of adjacent pixels to the center pixel C.

In the present embodiment, the center pixel C may be processed by using adjacent pixel values N3, i.e., the adjacent pixel values X13, X22, X23, X24, X31, X32, X34, X35, X42, X43, X44 and X53 of the adjacent pixels from among the plurality of adjacent pixels, which are marked by a bold line. In this case, according to the related art, pixel values that correspond to pixels included in the first through fourth rows R1 through R4 are all stored.

FIG. 15 illustrates an example of first, second, and third pixel values P1, P2, and P3 that are stored in the pixel value storage unit 20a and the input buffer 30 of FIG. 1 when the M×N region of FIG. 14 is used, according to an embodiment of the present invention.

Referring to FIG. 15, the first pixel value storage unit 21 may store the first pixel values P1 that correspond to first pixels included in second through fourth rows R2 through R4. Also, the second pixel value storage unit 22 may store only a pixel value X13 that is included in a first row R1 and that is from among adjacent pixels included in a 5×5 region. Here, the pixel value X13 corresponds to a second pixel value P2. Also, the input buffer 30 may store third pixel values P3 corresponding to third pixels that are included in a fifth row R5 and that are from among the adjacent pixels included in the 5×5 region.

According to the present embodiment, the first pixel value storage unit 21 may store 96(=32×3) pixel values, and the second pixel value storage unit 22 may store one pixel value. Thus, the pixel value storage unit 20a may store 97(=96+1) pixel values, and compared to the comparative example of FIG. 5, the pixel value storage unit 20a stores 31 less pixel values. Thus, according to the present embodiment, a memory capacity required to store the first and second pixel values P1 and P2 is decreased.

FIG. 16 illustrates an example of first, second, and third pixel values P1, P2, and P3 that are stored in the pixel value storage unit 20a and the input buffer 30 of FIG. 1 when the M×N region of FIG. 14 is used, according to another embodiment of the present invention.

Referring to FIG. 16, the first pixel value storage unit 21 may store the first pixel values P1 that correspond to first pixels included in third and fourth rows R3 and R4. Also, the second pixel value storage unit 22 may store only pixel values X13, X22, X23, and X24 that are included in first and second rows R1 and R2 and that are from among adjacent pixels included in a 5×5 region. Here, the pixel values X13, X22, X23 and X24 correspond to second pixel values P2. Also, the input buffer 30 may store third pixel values P3 corresponding to third pixels that are included in a fifth row R5 and that are from among the adjacent pixels included in the 5×5 region.

According to the present embodiment, the first pixel value storage unit 21 may store 64(=32×2) pixel values, and the second pixel value storage unit 22 may store four pixel values. Thus, the pixel value storage unit 20a may store 68(=64+4) pixel values, and compared to the comparative example of FIG. 5, the pixel value storage unit 20a stores 60 less pixel values. Thus, according to the present embodiment, a memory capacity required to store the first and second pixel values P1 and P2 is decreased.

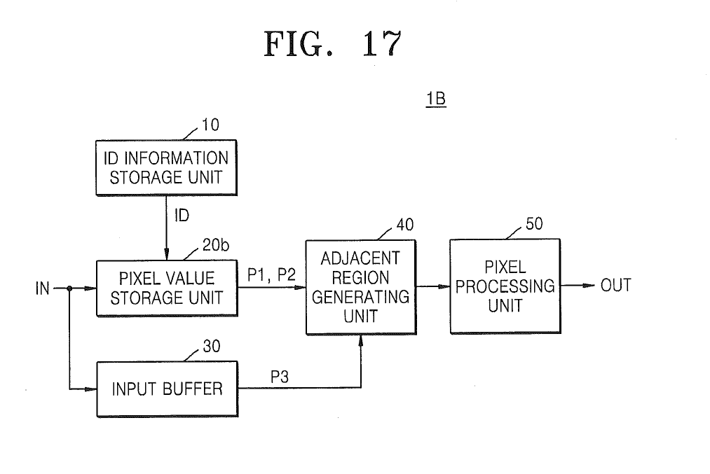

FIG. 17 is a block diagram of an image processing apparatus 1B according to another embodiment of the inventive concept.

Referring to FIGS. 2 and 17, the image processing apparatus 1B may include an ID information storage unit 10, a pixel value storage unit 20b, an input buffer 30, an adjacent region generating unit 40, and a pixel processing unit 50. Some of the elements of the image processing apparatus 1B are substantially the same as elements of the image processing apparatus 1A of FIG. 1. Like reference numerals in the drawings denote like elements, and the elements that are the same as those of the image processing apparatus 1A of FIG. 1 are not described again. Hereinafter, a difference between the image processing apparatus 1A of FIG. 1 and the image processing apparatus 1B of the present embodiment will be described.

The pixel value storage unit 20b may store a few pixel values from among a plurality of pixel values IN that are sequentially input, based on ID information. In the present embodiment, the number of pixel values stored in the pixel value storage unit 20b may be less than the number of pixel values that correspond to pixels included in (M−1) rows.

Based on the ID information, the pixel value storage unit 20b may store first pixel values P1 that correspond to first pixels included in one or more rows including a center row (i.e., a (M+1)/2ₜₕ row) in which a center pixel Cfrom among the plurality of pixel values IN that are sequentially input is disposed. In the present embodiment, the pixel value storage unit 20b may store first pixel values P1 that correspond to first pixels included in one or more rows including a third row R3 in which the center pixel Cis disposed.

The pixel value storage unit 20b may store second pixel values P2 that correspond to second pixels disposed above the first pixels from among the plurality of adjacent pixels included in an M×N region. In more detail, the pixel value storage unit 20b may store the second pixel values P2, i.e., residual pixel values of the plurality of adjacent pixels included in the M×N region, except for the first pixel values P1 and third pixel values P3 included in an Mₜₕ row.

Unlike the pixel value storage unit 20a of FIG. 1, the pixel value storage unit 20b may be embodied as one memory. In more detail, the pixel value storage unit 20b may be embodied as a plurality of line memories, and in this regard, the first pixel values P1 may be stored in some regions of the plurality of line memories, and the second pixel values P2 may be stored in the rest of the regions of the plurality of line memories.

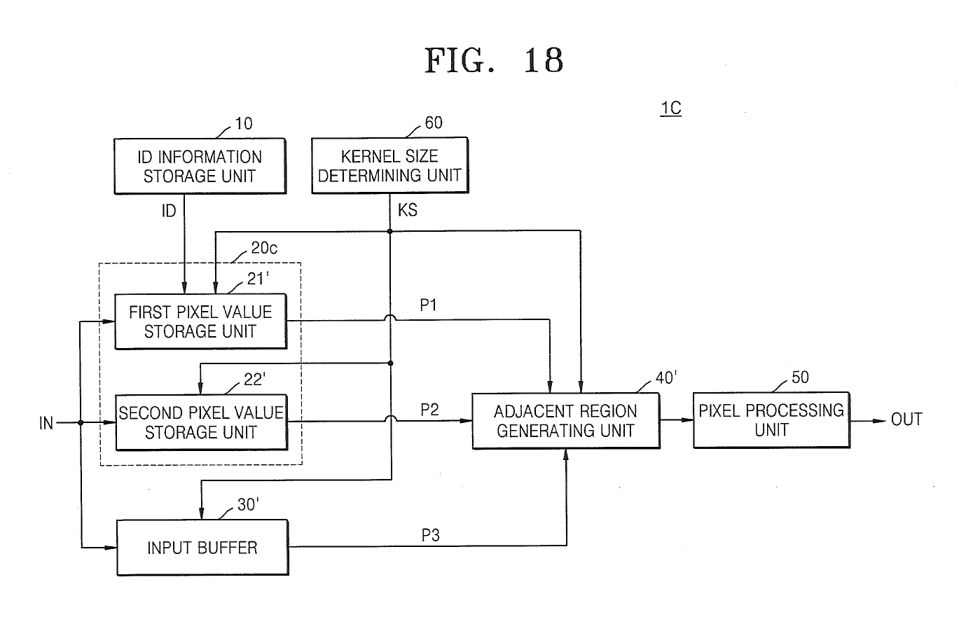

FIG. 18 is a block diagram of an image processing apparatus 1C according to another embodiment of the inventive concept.

Referring to FIGS. 2 and 18, the image processing apparatus 1C may include an ID information storage unit 10, a pixel value storage unit 20c, an input buffer 30′, an adjacent region generating unit 40′, a pixel processing unit 50, and a kernel size determining unit 60. The pixel value storage unit 20c may include a first pixel value storage unit 21′ and a second pixel value storage unit 22′. Some of the elements of the image processing apparatus 1C are substantially the same as elements of the image processing apparatus 1A of FIG. 1. Like reference numerals in the drawings denote like elements, and the elements that are the same as those of the image processing apparatus 1A of FIG. 1 are not described again. Hereinafter, a difference between the image processing apparatus 1A of FIG. 1 and the image processing apparatus 1C of the present embodiment will be described.

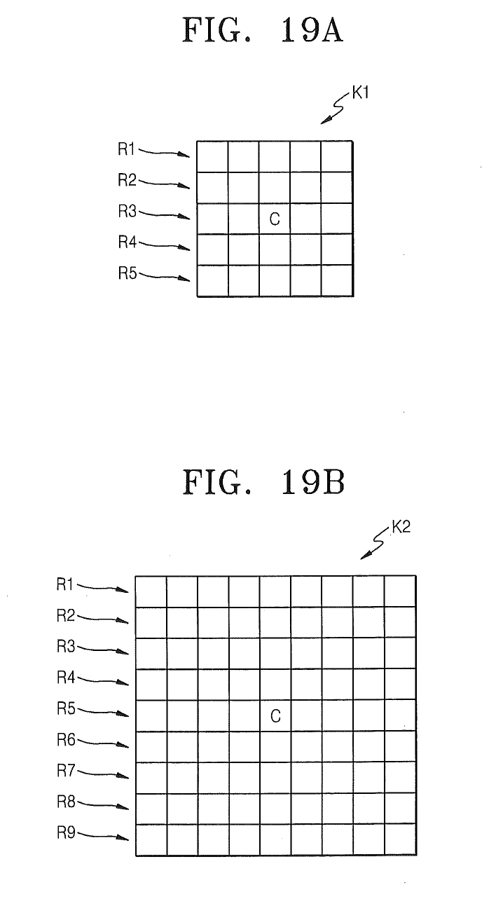

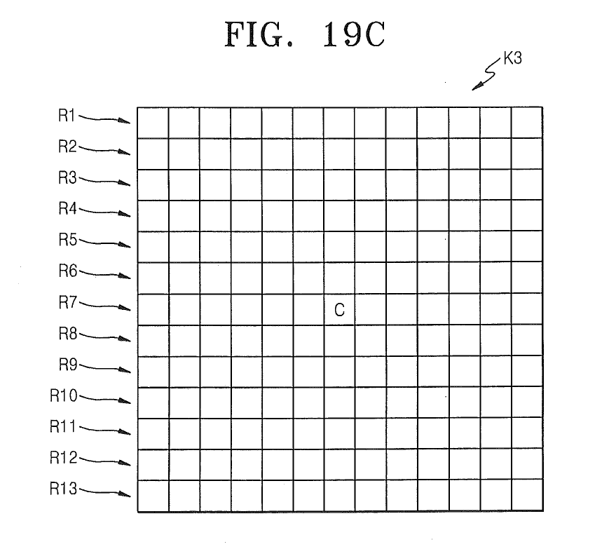

The kernel size determining unit 60 may selectively determine values of M and N, may determine a kernel size KS of a kernel that is an M×N region, and may provide the determined kernel size KS to the first pixel value storage unit 21′ and the second pixel value storage unit 22′, the input buffer 30′, and the adjacent region generating unit 40′. The kernel size KS that is determined by the kernel size determining unit 60 will be described below with reference to FIGS. 19A through 19C.

FIGS. 19A through 19C illustrate examples of kernels K1, K2, and K3 that have sizes determined by the kernel size determining unit 60 of FIG. 18 according to some embodiments of the inventive concept.

Referring to FIG. 19A, the kernel size determining unit 60 may determine each of the values of M and N as 5, so that the kernel K1 may have a 5×5 region that includes first through fifth rows R1 through R5. A center pixel C to be processed is disposed in the third row R3, which is a center row.

Referring to FIG. 19B, the kernel size determining unit 60 may determine each of the values of M and N as 9, so that the kernel K2 may have a 9×9 region that includes first through ninth rows R1 through R9. A center pixel C to be processed is disposed in the fifth row R5, which is a center row.

Referring to FIG. 19C, the kernel size determining unit 60 may determine each of the values of M and N as 13, so that the kernel K3 may have a 13×13 region that includes first through thirteenth rows R1 through R13. A center pixel C to be processed is disposed in the seventh row R7, which is a center row.

Referring back to FIG. 18, the kernel size determining unit 60 may adaptively determine the kernel size KS according to an environment in which an image is captured. In more detail, when the image is captured in an outdoor environment, the captured image may have small noise, and thus the kernel size determining unit 60 may determine the kernel size KS to be relatively small, e.g., a 5×5 region. On the other hand, when the image is captured in a night environment, the captured image may have a large amount of noise associated therewith, and thus, the kernel size determining unit 60 may determine the kernel size KS to be relatively large, e.g., a 13×13 region.

Based on ID information, the first pixel value storage unit 21′ may store first pixel values P1 that correspond to first pixels included in one or more rows including a center row (i.e., a (M+1)/2ₜₕ row) in which the center pixel C from among a plurality of pixel values IN that are sequentially input is disposed. In the present embodiment, the first pixel value storage unit 21′ may adaptively determine the number of pixel values to be stored, based on the kernel size KS.

For example, when the kernel size KS is 5×5, the first pixel value storage unit 21′ may store first pixel values P1 that correspond to first pixels included in one or more rows including the third row R3 that is the center row in which the center pixel Cis disposed. In one embodiment, the first pixel value storage unit 21′ may store first pixel values P1 that correspond to first pixels included in the third and fourth rows R3 and R4. In another embodiment, the first pixel value storage unit 21′ may store first pixel values P1 that correspond to first pixels included in the second through fourth rows R2 through R4.

When the kernel size KS is 9×9, the first pixel value storage unit 21′ may store first pixel values P1 that correspond to first pixels included in one or more rows including the fifth row R5 that is the center row in which the center pixel C is disposed. In one embodiment, the first pixel value storage unit 21′ may store first pixel values P1 that correspond to first pixels included in the fifth through eighth rows R5 through R8. In another embodiment, the first pixel value storage unit 21′ may store first pixel values P1 that correspond to first pixels included in the fourth through eighth rows R4 through R8. In another embodiment, the first pixel value storage unit 21′ may store first pixel values P1 that correspond to first pixels included in the third through eighth rows R3 through R8. In another embodiment, the first pixel value storage unit 21′ may store first pixel values P1 that correspond to first pixels included in the second through eighth rows R2 through R8.

When the kernel size KS is 13×13, the first pixel value storage unit 21′ may store first pixel values P1 that correspond to first pixels included in one or more rows including the seventh row R7 that is the center row in which the center pixel Cis disposed. In one embodiment, the first pixel value storage unit 21′ may store first pixel values P1 that correspond to first pixels included in the seventh through twelfth rows R7 through R12. In another embodiment, the first pixel value storage unit 21′ may store first pixel values P1 that correspond to first pixels included in the sixth through twelfth rows R6 through R12. In another embodiment, the first pixel value storage unit 21′ may store first pixel values P1 that correspond to first pixels included in the fifth through twelfth rows R5 through R12. In another embodiment, the first pixel value storage unit 21′ may store first pixel values P1 that correspond to first pixels included in the fourth through twelfth rows R4 through R12. In another embodiment, the first pixel value storage unit 21′ may store first pixel values P1 that correspond to first pixels included in the third through twelfth rows R3 through R12. In another embodiment, the first pixel value storage unit 21′ may store first pixel values P1 that correspond to first pixels included in the second through twelfth rows R2 through R12.

The second pixel value storage unit 22′ may store second pixel values P2 that correspond to second pixels disposed above the first pixels from among the plurality of adjacent pixels included in the M×N region. In the present embodiment, the second pixel value storage unit 22′ may adaptively determine the number of pixel values to be stored, based on the kernel size KS.

For example, when the kernel size KS is 5×5, the second pixel value storage unit 22′ may store second pixel values P2 that are included in the first row R1 or the first and second rows R1 and R2 and that are from among the plurality of adjacent pixels included in the 5×5 region. When the kernel size KS is 9×9, the second pixel value storage unit 22′ may store second pixel values P2 that are included in the first row R1, the first and second rows R1 and R2, the first through third rows R1 through R3, or the first through fourth rows R1 through R4 and that are from among the plurality of adjacent pixels included in the 9×9 region. When the kernel size KS is 13×13, the second pixel value storage unit 22′ may store second pixel values P2 that are included in the first row R1, the first and second rows R1 and R2, the first through third rows R1 through R3, the first through fourth rows R1 through R4, the first through fifth rows R1 through R5, or the first through sixth rows R1 through R6 and that are from among the plurality of adjacent pixels included in the 13×13 region.

The input buffer 30′ may store the plurality of pixel values IN that are sequentially input, and a size of the input buffer 30′ may vary according to a value of N. In more detail, the input buffer 30′ may store third pixel values P3 corresponding to N third pixels that are included in the Mₜₕ row and that are from among the plurality of adjacent pixels included in the M×N region. In the present embodiment, the input buffer 30′ may adaptively determine the number of pixel values to be stored, based on the kernel size KS.

For example, when the kernel size KS is 5×5, the input buffer 30′ may store five third pixel values P3 that are included in the fifth row R5. When the kernel size KS is 9×9, the input buffer 30′ may store nine third pixel values P3 that are included in the ninth row R9. When the kernel size KS is 13×13, the input buffer 30′ may store thirteen third pixel values P3 that are included in the thirteenth row R13.

The adjacent region generating unit 40′ may generate an adjacent region including a plurality of adjacent pixels used to process the center pixel C, based on the first, second, and third pixel values P1, P2, and P3 that are provided by the pixel value storage unit 20c and the input buffer 30′. In the present embodiment, the adjacent region generating unit 40′ may vary a size of the adjacent region, based on the kernel size KS.

For example, when the kernel size KS is 5×5, the adjacent region generating unit 40′ may generate an adjacent region including a plurality of adjacent pixels included in the 5×5 region. When the kernel size KS is 9×9, the adjacent region generating unit 40′ may generate an adjacent region including a plurality of adjacent pixels included in the 9×9 region. When the kernel size KS is 13×13, the adjacent region generating unit 40′ may generate an adjacent region including a plurality of adjacent pixels included in the 13×13 region.

As described above, according to the present embodiment, the kernel size KS is adaptively determined according to the environment in which an image is captured, so that a memory capacity required to embody the first and second pixel value storage units 21′ and 22′, and the input buffer 30′ may be adaptively determined.

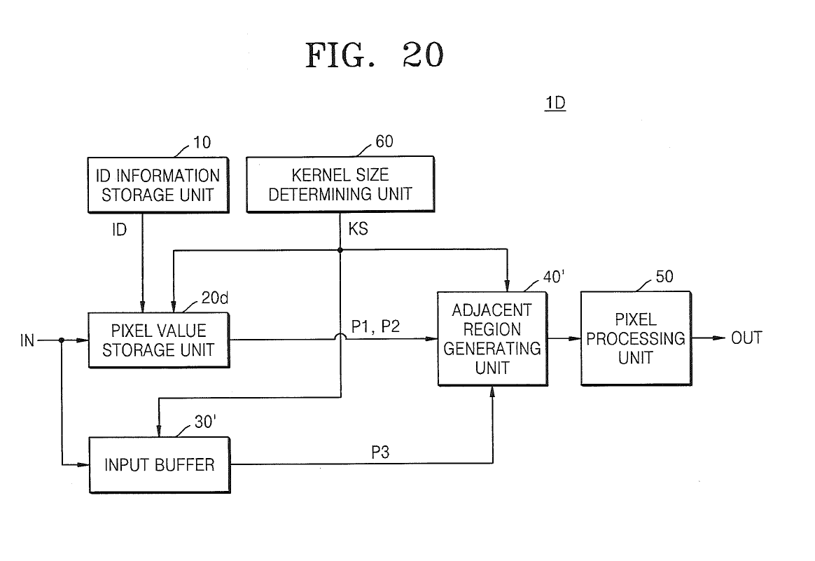

FIG. 20 is a block diagram of an image processing apparatus 1D according to another embodiment of the inventive concept.

Referring to FIGS. 2 and 20, the image processing apparatus 1D may include an ID information storage unit 10, a pixel value storage unit 20d, an input buffer 30′, an adjacent region generating unit 40′, a pixel processing unit 50, and a kernel size determining unit 60. Some of the elements of the image processing apparatus 1D are substantially equal to elements of the image processing apparatus 1C of FIG. 19. Like reference numerals in the drawings denote like elements, and the elements that are the same as those of the image processing apparatus 1C of FIG. 19 are not described again. Hereinafter, a difference between the image processing apparatus 1C of FIG. 19 and the image processing apparatus 1D of the present embodiment will be described.

The pixel value storage unit 20d may store a few pixel values from among a plurality of pixel values IN that are sequentially input, based on ID information. In the present embodiment, the number of pixel values stored in the pixel value storage unit 20d may be less than the number of pixel values that correspond to pixels included in (M−1) rows. In the present embodiment, the pixel value storage unit 20d may adaptively determine the number of pixel values to be stored, based on a kernel size KS.

In more detail, based on the ID information, the pixel value storage unit 20d may store first pixel values P1 that correspond to first pixels included in one or more rows including a center row (i.e., a (M+1)/2ₜₕ row) in which a center pixel C from among the plurality of pixel values IN that are sequentially input is disposed.

Also, the pixel value storage unit 20d may store second pixel values P2 that correspond to second pixels disposed above the first pixels from among the plurality of adjacent pixels included in an M×N region. In more detail, the pixel value storage unit 20d may store the second pixel values P2, i.e., residual pixel values of the plurality of adjacent pixels included in the M×N region, except for the first pixel values P1 and third pixel values P3 included in an Mₜₕ row.

Unlike the pixel value storage unit 20c of FIG. 19, the pixel value storage unit 20d may be embodied as one memory. In more detail, the pixel value storage unit 20d may be embodied as a plurality of line memories, and in this regard, the first pixel values P1 may be stored in some regions of the plurality of line memories, and the second pixel values P2 may be stored in the rest of the regions of the plurality of line memories.

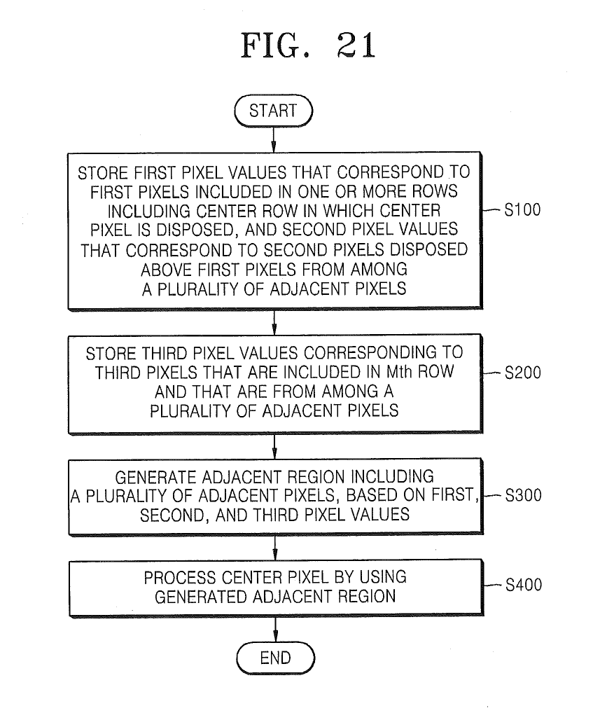

FIG. 21 is a flowchart illustrating a method of processing an image, according to an embodiment of the present invention.

Referring to FIG. 21, the method involves processing a center pixel by using a plurality of adjacent pixels included in an M×N region, and includes operations that are processed in chronological order by one of the image processing apparatuses 1A, 1B, 1C, and 1D of FIGS. 1, 17, 18, and 20. Thus, although descriptions of some features are omitted here, the aforementioned features with reference to the image processing apparatuses 1A, 1B, 1C, and 1D of FIGS. 1, 17, 18, and 20 also apply to the method of FIG. 21.

In operation S100, first pixel values that correspond to first pixels included in one or more rows including a center row in which the center pixel is disposed, and second pixel values that correspond to second pixels disposed above the first pixels from among a plurality of adjacent pixels are stored. Here, the number of first and second pixel values to be stored may be less than the number of pixel values that correspond to pixels included in (M−1) rows.

In operation S200, third pixel values corresponding to third pixels that are included in an Mₜₕ row and that are from among the plurality of adjacent pixels are stored. Here, the number of third pixel values to be stored may be determined according to a value of N.

In operation S300, an adjacent region, including the plurality of adjacent pixels, is generated based on the first through third pixel values.

In operation S400, the center pixel is processed by using the adjacent region. In more detail, a center pixel value of the center pixel may be changed or maintained by using the adjacent region. When the center pixel is a defective pixel, a pixel value of the defective pixel may be corrected by using the adjacent region.

In one embodiment, the method may further include an operation of storing ID information that is used to identify the center pixel value of the center pixel from among the plurality of pixel values that are sequentially input. Here, the ID information may include coordinate information regarding the center pixel input order information regarding the center pixel, or the like.

In another embodiment, the method may further include an operation of selectively determining values of M and N and then determining a kernel size of a kernel that is an M×N region. According to the determined kernel size, the number of first through third pixel values to be stored may be adaptively changed.

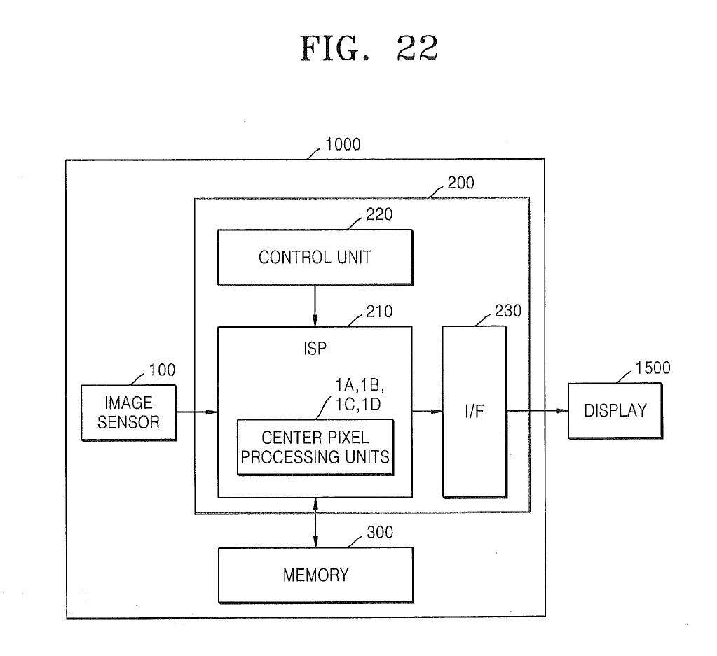

FIG. 22 is a block diagram of a photographing device 1000 including one of the image processing apparatuses, according to an embodiment of the present invention.

Referring to FIG. 22, the photographing device 1000 may be a camera that includes an image sensor 100, a processor 200, and a memory 300. The processor 200 may be a microprocessor, an image processor, or an application-specific integrated circuit (ASIC). In the present embodiment, the photographing device 1000 may be connected to a display 1500. In another embodiment, the photographing device 1000 and the display 1500 may be integrally formed.

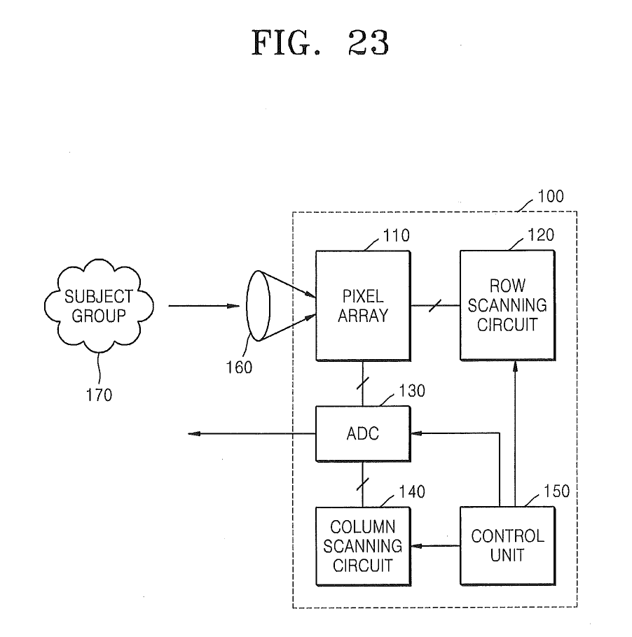

FIG. 23 is a detailed block diagram of the image sensor 100 of FIG. 22.

Referring to FIG. 23, the image sensor 100 may include a pixel array 110, a row scanning circuit 120, an analog-to-digital converter (ADC) unit 130, a column scanning circuit 140, and a control unit 150. A light-receiving lens 160 may focus light on the pixel array 110, wherein the light is received from a subject group 170.

The pixel array 110 may include a plurality of pixels (not shown) that convert the light focused by the light-receiving lens 160 into electrical signals. The pixel array 110 may include color pixels and/or depth pixels. For example, when the pixel array 110 includes color pixels, the pixel array 110 may provide two-dimensional color image information, such as RGB with respect to the subject group 170. Alternatively, when the pixel array 110 includes depth pixels, the pixel array 110 may provide two-dimensional black-and-white image information, such as information of a distance between the image sensor 100 and the subject group 170, and an offset, amplitude, or the like with respect to the subject group 170.

The row scanning circuit 120 may receive control signals from the control unit 150 and then may control row addressing and row scanning of the pixel array 110. The row scanning circuit 120 may apply a signal to the pixel array 110 so as to activate a row line in order to select the row line from among row lines. In one embodiment, the row scanning circuit 120 may include a row decoder for selecting a row line in the pixel array 110, and a row driver for supplying a signal to activate the selected row line.

The ADC unit 130 may convert an analog signal output from the pixel array 110 into a digital signal and thus may provide a pixel value, i.e., pixel data. A pixel value IN to be applied to the image processing apparatuses 1A, 1B, 1C, and 1D of FIGS. 1 through 20 may be the pixel value, i.e., the pixel data that is output from the ADC unit 130. In one embodiment, the ADC unit 130 may perform column analog-to-digital conversion in which analog signals are converted in parallel by using multiple ADCs that are connected to column lines, respectively. In another embodiment, the ADC unit 130 may perform a single analog-to-digital conversion in which analog signals are sequentially converted by using one ADC.

The column scanning circuit 140 may receive control signals from the control unit 150 and then may control column addressing and column scanning of the pixel array 110. The column scanning circuit 140 may output the digital output signal from the ADC unit 130 to a digital signal processing circuit (not shown) or an external host (not shown). For example, the column scanning circuit 140 may output a horizontal scanning control signal to the ADC unit 130, and then may sequentially select the ADCs in the ADC unit 130. In one embodiment, the column scanning circuit 140 may include a column decoder for selecting one of the ADCs, and a column driver for guiding an output from the selected ADC to a horizontal transmission line.

The control unit 150 may control the row scanning circuit 120, the ADC unit 130, and the column scanning circuit 140. In more detail, the control unit 150 may supply control signals, including clock signals, timing control signals, or the like which are used to operate the row scanning circuit 120, the ADC unit 130, and the column scanning circuit 140. In one embodiment, the control unit 150 may include a logic control circuit, a phase-locked loop (PLL) circuit, a timing control circuit, a communication interface circuit, and the like. In another embodiment, a function of the control unit 150 may be performed by a processor, such as an engine that is separately arranged.

Referring back to FIG. 22, the processor 200 may include an image signal processing unit 210, a control unit 220, and an interface (IF) 230. The image signal processing unit 210 may include center pixel processing units 1A, 1B, 1C, and 1D, and in this regard, the center pixel processing units 1A, 1B, 1C, and 1D may respectively include the image processing apparatuses 1A, 1B, 1C, and 1D that are described above with reference to FIGS. 1 through 20.

The image signal processing unit 210 may receive image data output from the image sensor 100 and then may perform signal processing on the image data. The control unit 220 may output a control signal to the image signal processing unit 210 and may be embodied as a central processing unit (CPU). The IF 230 may transmit the signal-processed image data to the display 1500 so as to reproduce the image data. The memory 300 may store the image data that is signal-processed by the image signal processing unit 210.

The center pixel processing units 1A, 1B, 1C, and 1D of the image signal processing unit 210 may receive a plurality of pixel values output from the image sensor 100 and may perform signal processing on the center pixel by using adjacent pixels. In more detail, each of the center pixel processing units 1A, 1B, 1C, and 1D may include a pixel value storage unit (not shown) that stores first pixel values that correspond to first pixels included in one or more rows including a center row in which the center pixel is disposed, and second pixel values that correspond to second pixels disposed above the first pixels from among a plurality of adjacent pixels. Here, the number of first and second pixel values stored in the pixel value storage unit may be less than the number of pixel values that correspond to pixels included in (M−1) lines.

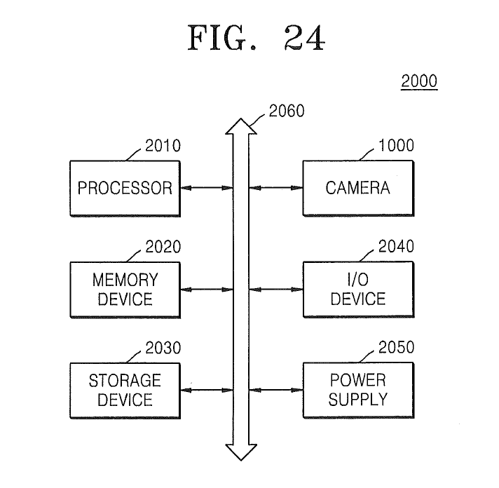

FIG. 24 is a block diagram of a computing system 2000 that includes the photographing device 1000 of FIG. 22, according to an embodiment of the inventive concept.

Referring to FIG. 24, the computing system 2000 may include a processor 2010, a memory device 2020, a storage device 2030, an input/output (I/O) device 2040, a power supply 2050, and a camera 1000 (the photographing device 1000 of FIG. 22may be embodied as the camera 1000). Although not illustrated in FIG. 24, the computing system 2000 may further include ports for communication with a video card, a sound card, a memory card, a universal serial bus (USB) device, or other electronic devices.

The processor 2010 may perform specific calculations or specific tasks. According to various embodiments, the processor 2010 may be a microprocessor, a CPU, or the like. The processor 2010 may perform communication with the memory device 2020, the storage device 2030, and the I/O device 2040 via a bus 2060, such as an address bus, a control bus, or a data bus. According to various embodiments, the processor 2010 may be connected to an extension bus such as a peripheral component interconnect (PCI) bus.

The memory device 2020 may store data used to operate the computing system 2000. For example, the memory device 2020 may be embodied as a dynamic random access memory (DRAM), a mobile DRAM, an SRAM, a PRAM, an FRAM, an RRAM, and/or an MRAM.

The storage device 2030 may include a solid-state drive (SSD), a hard disk drive (HDD), a CD-ROM, or the like.

The I/O device 2040 may include an input means including a keyboard, a keypad, a mouse, and the like, and an output means including a printer, a display, and the like. The power supply 2050 may supply an operation voltage for operations of the computing system 2000.

The camera 1000 may be connected to the processor 2010 via the bus 2060 or another communication link and then may perform communication. As described above, the camera 1000 may process a center pixel by using a plurality of adjacent pixels included in an M×N region. In more detail, the camera 1000 may include a pixel value storage unit (not shown) that stores first pixel values that correspond to first pixels included in one or more rows including a center row in which the center pixel is disposed, and second pixel values that correspond to second pixels disposed above the first pixels from among a plurality of adjacent pixels. Here, the number of first and second pixel values stored in the pixel value storage unit may be less than the number of pixel values that correspond to pixels included in (M−1) lines.

The camera 1000 may be embodied as various package types. For example, at least some elements of the camera 1000 may be mounted by using packages, such as a package on package (PoP), ball grid arrays (BGAs), chip scale packages (CSPs), a plastic leaded chip carrier (PLCC), a plastic dual in-line package (PDIP), a die in waffle pack, a die in wafer form, a chip on board (COB), a ceramic dual in-line package (CERDIP), a plastic metric quad flat pack (MQFP), a thin quad flatpack (TQFP), a small outline (SOIC), a shrink small outline package (SSOP), a thin small outline (TSOP), a thin quad flatpack (TQFP), a system in package (SIP), a multi chip package (MCP), a wafer-level fabricated package (WFP), a wafer-level processed stack package (WSP), or the like.

The computing system 2000 may include all computing systems that use the camera 1000. For example, the computing system 2000 may include a digital camera, a mobile phone, a personal digital assistant (PDA), a portable multimedia player (PMP), a smart phone, and the like.

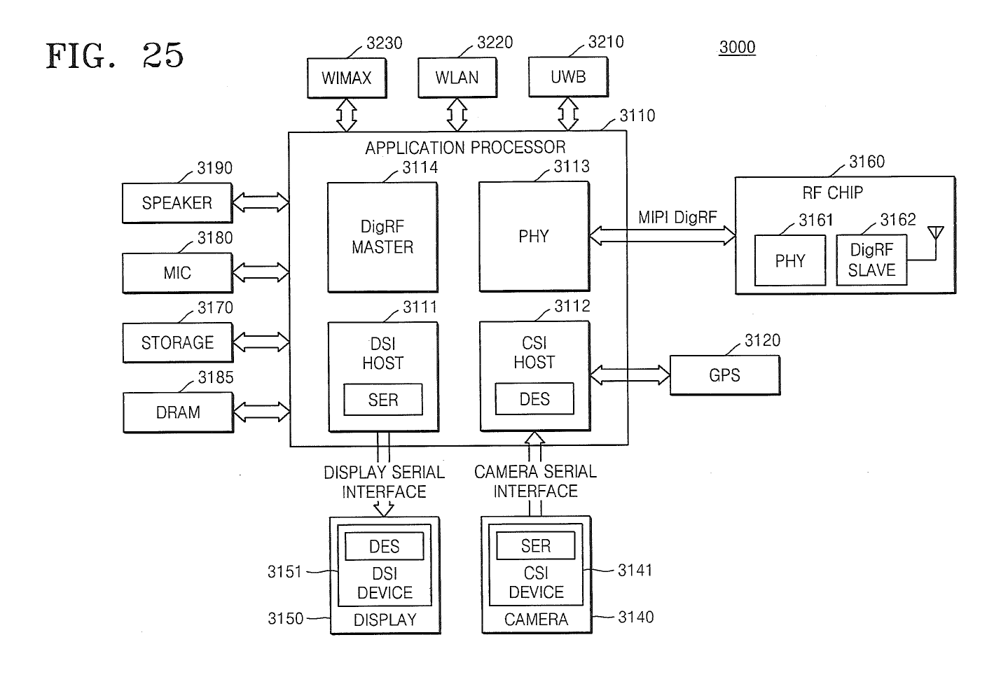

FIG. 25 is a block diagram illustrating an interface used in the computing system of FIG. 24. Referring to FIG. 25, the computing system 3000 may be embodied as a data processing apparatus capable of using or supporting a mobile industry processor interface (MIPI). The computing system 3000 may include an application processor 3110, a camera 3140, a display 3150, and the like. A camera serial interface (CSI) host 3112 of the application processor 3110 may perform serial communication with a CSI device 3141 of the camera 3140 via a CSI.

In one embodiment, the CSI host 3112 may include a deserializer DES, and the CSI device 3141 may include a serializer SER. A display serial interface (DSI) host 3111 of the application processor 3110 may perform serial communication with a DSI device 3151 of the display 3150 via a DSI.

In one embodiment, the DSI host 3111 may include a serializer (SER), and the DSI device 3151 may include a deserializer DES. The computing system 3000 may further include a radio frequency (RF) chip 3160 for communication with the application processor 3110. A PHY 3113 of the computing system 3000, and a PHY 3161 of the RF chip 3160 may exchange data according to a MIPIDigRF. Also, the application processor 3110 may further include a DigRF master 3114 that controls the data exchange of the PHY 3161 according to the MIPIDigRF.

The computing system 3000 may include a global positioning system (GPS) 3120, a storage 3170, a microphone (MIC) 3180, a DRAM 3185, and a speaker 3190. Also, the computing system 3000 may perform communication by using a Ultra WideBand (UWB) 3210, a wireless local area network (WLAN) 3220, a Worldwide Interoperability for Microwave Access (WIMAX) 3230, or the like. A structure and interfaces of the computing system 3000 are not limited thereto.

While the inventive concept has been particularly shown and described with reference to exemplary embodiments thereof, it will be understood that various changes in form and details may be made therein without departing from the spirit and scope of the following claims.

What is claimed is:

1. An image processing apparatus for processing a center pixel by using a plurality of adjacent pixels comprised in an M×N region, the image processing apparatus comprising:
a pixel value storage unit for storing first pixel values that correspond to first pixels comprised in one or more rows comprising a center row in which the center pixel is disposed, and second pixel values that correspond to second pixels disposed above the first pixels from among the plurality of adjacent pixels; and
a pixel processing unit for processing the center pixel, based on the first and second pixel values,
wherein the M and N are natural numbers that are equal to or greater than two.

2. The image processing apparatus of claim 1, wherein the number of the first and second pixel values stored in the pixel value storage unit is less than the number of pixel values that correspond to pixels comprised in (M−1) rows.

3. The image processing apparatus of claim 1, wherein the pixel value storage unit comprises:
a line memory for storing the first pixel values; and
a memory for storing the second pixel values.

4. The image processing apparatus of claim 3, wherein the number of the first pixel values stored in the line memory is less than the number of pixel values that correspond to pixels comprised in (M−1) rows.

5. The image processing apparatus of claim 1, wherein the pixel value storage unit comprises a line memory for storing the first and second pixel values.

6. The image processing apparatus of claim 1, further comprising an identification (ID) information storage unit for storing ID information that is used to identify a center pixel value corresponding to the center pixel from among a plurality of pixel values that are sequentially input.

7. The image processing apparatus of claim 6, wherein the ID information comprises coordinate information regarding the center pixel and/or input order information regarding the center pixel.

8. The image processing apparatus of claim 1, further comprising an input buffer for storing a plurality of pixel values that are sequentially input.

9. The image processing apparatus of claim 8, wherein the input buffer stores third pixel values corresponding to third pixels that are comprised in an Mₜₕ row and that are from among the plurality of adjacent pixels.

10. The image processing apparatus of claim 9, further comprising an adjacent region generating unit for generating an adjacent region comprising the plurality of adjacent pixels, based on the first, second, and third pixel values.

11. The image processing apparatus of claim 10, wherein the pixel processing unit is configured to change or maintain a center pixel value of the center pixel by using the generated adjacent region.

12. The image processing apparatus of claim 1, further comprising a kernel size determining unit for selectively determining values of the M and N numbers and then determining a size of a kernel that is the M×N region.

13. The image processing apparatus of claim 1, wherein the center pixel is a defective pixel, and the pixel processing unit corrects a value of the defective pixel, based on the first and second pixel values.

14. A method of processing an image by processing a center pixel by using a plurality of adjacent pixels comprised in an M×N region, the method comprising:
storing first pixel values that correspond to first pixels comprised in one or more rows comprising a center row in which the center pixel is disposed, and second pixel values that correspond to second pixels disposed above the first pixels from among the plurality of adjacent pixels; and
processing the center pixel, based on the first and second pixel values,
wherein the M and N are natural numbers that are equal to or greater than two.

15. The method of claim 14, further comprising:
storing third pixel values corresponding to third pixels that are comprised in an Mₜₕ row and that are from among the plurality of adjacent pixels; and
generating an adjacent region comprising the plurality of adjacent pixels, based on the first, second, and third pixel values.

16. A method of processing an image by processing a center pixel by using a plurality of adjacent pixels comprised in an M×N region, the method comprising:
storing first pixel values that correspond to first pixels from a first plurality of rows of the M rows that includes a center row in which the center pixel is disposed;
storing second pixel values that correspond to second pixels from a second plurality of rows of the M rows, the second plurality of M rows being disposed above the first plurality of M rows; and
processing the center pixel based on the first and second pixel values.

17. The method of claim 16, further comprising:
storing third pixel values that correspond to third pixels from one of the M rows that is separate from the first plurality of rows of the M rows and the second plurality of rows of the M rows; and
wherein processing the center pixel comprises processing the center pixel based on the first, second, and third pixel values.

18. The method of claim 17, wherein a number of the first plurality of rows and the second plurality of rows combined is M−1.

19. The method of claim 17, further comprising:
selectively determining values of the M and N numbers; and
determining a size of a kernel that is the M×N region.

20. The method of claim 17, further comprising:
changing a value of the center pixel based on the first, second, and third pixel values; or
maintaining the value of the center pixel based on the first, second, and third pixel values.
